(19) United States
(12) Patent Application Publication
(10) Pub. No.: US 2008/0106540 A1
(43) Pub. Date: May 8, 2008

(54) Over-driving compensation method to shorten the response time of a TN/STN passive matrix liquid crystal display

(75) Inventors: Chin-Wei Chien, Taipei City (TW); Shi-Ming Cheng, Tainan City (TW)

Correspondence Address: BIRCH STEWART KOLASCH & BIRCH, PO BOX 747, FALLS CHURCH, VA, 22040-0747, US

(73) Assignee: Sitronix Technology Corp.

(21) Appl. No.: 11/593,119

(22) Filed: Nov. 6, 2006

(51) Int. Cl. G06F 3/038

(52) U.S. Cl. 345/212

(57) ABSTRACT

The present invention discloses an over-driving compensation method to shorten the response time of a passive matrix liquid crystal display, wherein N frames are arranged into a super-frame; the data of the current frame is compared with the data of the previous frame; once the data of the current frame is different from the data of the previous frame, the pictures are determined to be moving pictures; and when the pictures are determined to be moving pictures, an over-driving voltage, which is higher/lower than the traditional high-level driving voltage/the traditional low-level driving voltage, is assigned to each of from the ith frame to the jth frame of each super-frame. Thereby, the liquid crystal can faster approach or reach the specified target brightness. So the blurring of moving pictures will be greatly reduced.

### FIELD OF THE INVENTION

The present invention relates to a passive matrix-LCD driving technology, particularly to an over-driving compensation method, which enables the passive matrix TN/STN LCD adopting an APT (Alt & Pleshko theory) driving technology to display moving pictures clear.

### BACKGROUND OF THE INVENTION

As LCD (Liquid Crystal Display) has the advantages of slimness, compactness and lightweight and consumes less power than the conventional CRT (Cathode Ray Tube), LCD has been gradually replacing CRT recently.

According to the driving methods, the flap-panel liquid crystal display (LCD) may be divided into the passive matrix LCD (PM-LCD) and the active matrix LCD (AM-LCD). In the passive matrix LCD, X-direction transparent ITO (Indium Tin Oxide) electrodes and Y-direction electrodes are respectively formed on two glass plates, and one glass plate is superimposed over the other one with liquid crystal filled. The intersections of the X-direction electrodes and the Y-direction electrodes are the pixels of LCD. External driving voltage is applied between the X-direction electrodes and the Y-direction electrodes to enable the rotation of liquid crystal molecules.

In the active matrix LCD, each pixel has a switch element and a complementary capacitor, and each pixel is independently driven by the elements on the pixel. In the active matrix LCD, TFTs (thin film transistors) are formed on the panel; therefore, the active matrix LCD is also called TFT-LCD (Thin Film Transistor Liquid Crystal Display).

Refer to FIG. 1 a diagram schematically showing the architecture of an m×n passive matrix LCD. The pixels 1 of a passive matrix LCD, including the common TN (Twisted Nematic) LCD and STN (Super Twisted Nematic) LCD, are not controlled by non-linear elements but are the intersections of the horizontal routings of common electrodes 2 and the vertical routings of segment electrodes 3.

In principle, the electro-optical effect of liquid crystal, which is generated by the RMS (Root Mean Square) values of the applied voltage, is used in the operation of the passive matrix LCD. The response time of liquid crystal must be much longer than the scanning period of the driving pulse. If the frame rate is 60 Hz, the active time of each horizontal scanning line (the common electrode 2) will be 16.67 ms, and the response time of liquid crystal is generally 200 ms, which is the necessary condition that liquid crystal responds to the RMS values.

However, blurring will appear in the moving pictures of the LCD adopting the traditional APT (Alt & Pleshko theory) driving method because the TN/STN LCD response time is too slowly. If LCD adopts a fast-response liquid crystal, the display picture may flicker, and the picture quality will be greatly reduced.

### SUMMARY OF THE INVENTION

One objective of the present invention is to shorten the response time of the passive matrix LCD adopting the APT (Alt & Pleshko theory) driving method, including the TN LCD and the STN LCD, to reduce the display moving picture blurring phenomenon.

To achieve the above-mentioned objective, the present invention proposes an over-driving compensation method to shorten the response time of a passive matrix LCD, wherein for the passive matrix LCD (such as the TN LCD and the STN LCD) adopting the traditional APT (Alt & Pleshko theory) driving method, N frames containing segment-electrode picture data are arranged into a super-frame, and the current frame data is compared with the previous frame data; once the current data is different from the previous data, the pictures are moving pictures; next, an over-driving voltage, which is higher than the traditional high-level driving voltage of the segment electrode or lower than the traditional low-level driving voltage of the segment electrode, is given to each of from the ith frame to the jth frame with 2□N and 1□i, j□N, and the over-driving voltage is greater than or equal to 0 V and is lower than or equal to the highest of the LCD driving voltage. Thereby, the liquid crystal between the common electrodes and the segment electrodes can fast approach the target brightness of a specified high voltage.

Further, the present invention can respectively assign different voltages to different pictures, wherein a LUT (LookUp Table) circuit checks a table and sends out the values of the corresponding over-driving voltages, and the segment electrodes can thus correctly output the corresponding over-driving voltages. Thereby, the response time of the passive matrix LCD (such as TN LCD and the STN LCD) adopting the APT (Alt & Pleshko theory) driving method will be shortened, and the blurring of moving pictures will be greatly reduced.

### BRIEF DESCRIPTION OF THE DRAWINGS

FIG. 1 is a diagram schematically showing the architecture of an m×n passive matrix LCD.

FIG. 2 is a diagram schematically showing the driving waveforms of the pixel at the 1st column and the nth row of a traditional passive matrix LCD.

FIG. 3 is a diagram schematically showing the driving waveforms of the pixel at the 1st column and the nth row of the passive matrix LCD according to the present invention.

FIG. 4 is a block diagram schematically showing the lookup-table operation of the over-driving circuit according to the present invention.

FIG. 5 is another block diagram schematically showing the lookup-table operation of the over-driving circuit according to the present invention.

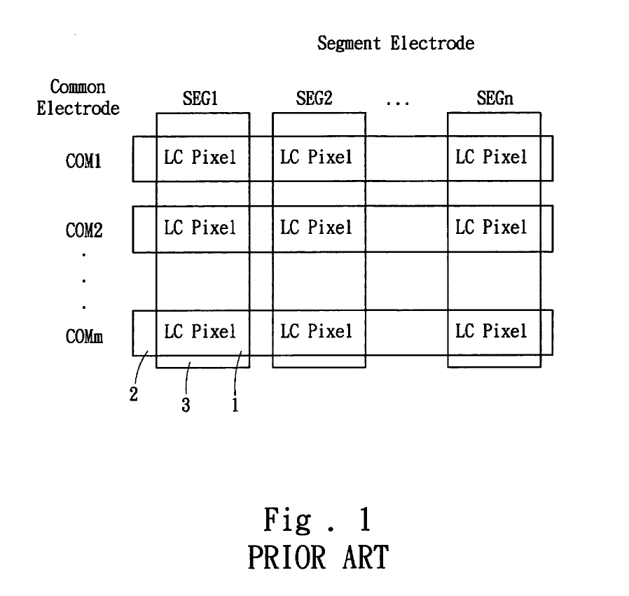

### DETAILED DESCRIPTION OF THE PREFERRED EMBODIMENTS

Below, the technical contents of the present invention are to be described in detail in cooperation with the embodiments. However, it should be noted that those embodiments are only to exemplify the present invention and should not be used to limit the scope of the present invention.

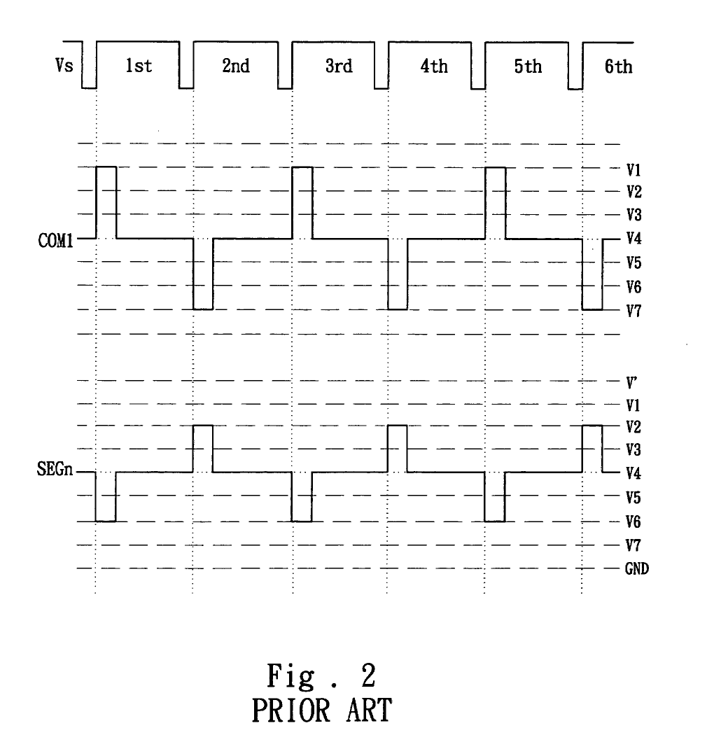

Refer to FIG. 2 a diagram schematically showing the driving waveforms of the pixel at the 1st column and the nth row of the traditional passive matrix LCD. The driving waveforms of the traditional passive matrix LCD (such as TN LCD and the STN LCD) adopting the APT (Alt & Pleshko theory) driving method include: a frame mark signal Vs, a common electrode signal COM1 and a segment electrode signal SEGn (Herein, the driving waveforms of the pixel in the 1st column and the nth row are used as the exemplification). In the traditional driving method, the identical high-level voltage V2 and the identical low-level voltage V6 (with respect to the reference voltage V4) are assigned to the segment electrodes in all frames.

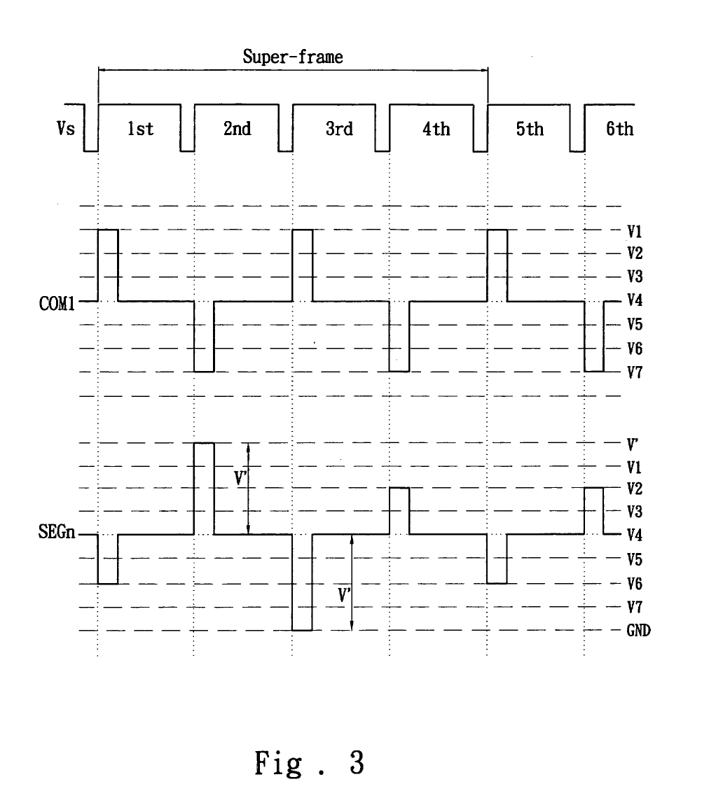

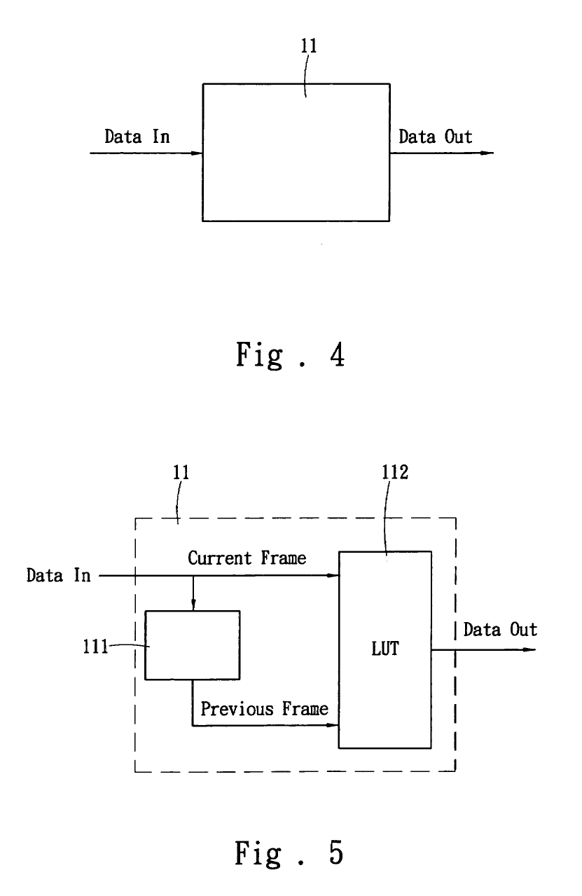

Refer to FIG. 3 a diagram schematically showing the driving waveforms of the pixel at the 1st column and the nth row of the passive matrix LCD according to the present invention. In this embodiment, we suppose that a super-frame is formed of four frames (N=4); a picture-comparing circuit 11 arranged behind the data-input bus (shown in FIG. 4) is used to compare the data of the current frame with the data of the previous frame; once the data of the current frame is different from the data of the previous frame, the pictures are determined to be moving pictures; next, the picture-comparing circuit 11 flexibly assigns an over-driving voltage V′, which is higher/lower than the traditional high-level driving voltage V2/the traditional low-level driving voltage V6 (such as the ground voltage GND), to each of from the ith frame to the jth frame of each super-frame, wherein 1□i, j□4, and 0□V′□the highest driving voltage of the LCD. In FIG. 3, i=2 and j=3; however, the picture-comparing circuit 11 may also assigns an over-driving voltage V′, which is higher/lower than the traditional high-level driving voltage V2/the traditional low-level driving voltage V6 (such as the ground voltage GND), to all the frames of each super-frame; otherwise, the picture-comparing circuit 11 may also assigns an over-driving voltage V′ to the ith frame and the jth frame of each super-frame (for example, i=1 and j=4). Thereby, the liquid crystal between the common electrodes 2 and the segment electrodes 3 can faster approach or reach the target brightness of the specified high-level voltage V2.

The electro-optical effect of liquid crystal, which is generated by the RMS (Root Mean Square) values of the applied voltage, is used in the operation of the traditional passive matrix LCD (such as TN LCD and the STN LCD) adopting the APT (Alt & Pleshko theory) driving method; therefore, the RMS values will not cause serious flicker and show good moving picture quality in the over-driving compensation method of the present invention.

Further, the present invention may also respectively assign different over-driving voltages V′ to different pictures. The picture-comparing circuit 11 compares the data of the current frame with the data of the previous frame stored in a storage device 111 inside (or outside) the driver IC. Once those two pieces of data are different, the pictures are determined to be moving pictures. When the pictures are determined to be moving pictures, an LUT (LookUp Table) circuit 112 checks a table and sends out the values of the corresponding over-driving voltages. The table checked by the LUT (LookUp Table) circuit 112 is an index matrix containing the values of over-driving voltages and can replace complicated calculation or non-linear calculation with a database of constants; therefore, the complicated calculation is omitted, and the processing efficiency is promoted. The output values of the corresponding over-driving voltages enable the segment electrodes 3 to output correct over-driving voltages V′. Thus, the response time of the traditional passive matrix LCD (such as TN LCD and the STN LCD) adopting the APT (Alt & Pleshko theory) driving method will be shortened, and the blurring of moving pictures will be greatly reduced.

The spirit of the present invention is to utilize the concept of the over-driving compensation method, which is originally used to shorten the response time of the large-size active-matrix TFT-LCD, to shorten the response time of the passive matrix TN/STN LCD. Besides, as the principle of the APT (Alt & Pleshko theory) driving method is to utilize the electro-optical effect of liquid crystal, which is generated by the RMS (Root Mean Square) values of the applied voltage, in the operation of the traditional passive matrix LCD, the RMS values of the applied voltage will not cause serious flicker in the over-driving compensation method of the present invention.

Those described above are the preferred embodiments to exemplify the present invention. However, it is not intended to limit the scope of the present invention. Any equivalent modification and variation according to the spirit of the present invention is to be also included within the scope of the present invention.

What is claimed is:

1. An over-driving compensation method to shorten the response time of a passive matrix liquid crystal display, which is applied to the traditional passive matrix adopting the Alt & Pleshko theory (APT) driving method, characterized in comprising the flowing steps:
arranging N frames of the picture data of a segment electrode into a super-frame; comparing the data of the current frame with the data of the previous frame; and once the data of the current frame is different from the data of the previous frame, assigning an over-driving voltage, which is higher/lower than the traditional high-level driving voltage/the traditional low-level driving voltage, to each of from the ith frame to the jth frame of each said super-frame, wherein 2□N, and 1□i, j□N, and said over-driving voltage is greater than 0 V and is smaller than or equal to the highest LCD driving voltage.

2. The over-driving compensation method according to claim 1, wherein a LUT (LookUp Table) circuit checks a table and respectively assigns different values of said over-driving voltages to different pictures.
